(19) United States
(12) Patent Application Publication
(10) Pub. No.: US 2008/0195670 A1
(43) Pub. Date: Aug. 14, 2008

(54) SYSTEM AND METHOD FOR LOG MANAGEMENT

(76) Inventors: Louis L. Boydstun, Wyoming, OH (US); Rao S. Bandaru, Mason, OH (US); Tim D. Gourley, Cincinnati, OH (US); Jayesh Thakkar, Pune (IN); Ritesh A. Dhope, Pune (IN)

Correspondence Address: SIEMANS PRODUCT LIFECYCLE MANAGEMENT SOFTWARE INC., 5800 GRANITE PARKWAY, SUITE 600, PLANO, TX, 75024, US

(21) Appl. No.: 11/673,982

(22) Filed: Feb. 12, 2007

(51) Int. Cl. G06F 17/30

(52) U.S. Cl. 707/202

(57) ABSTRACT

A system, method, and computer program for managing a plurality of software logs across a multi-tiered network having multiple depositories, comprising establishing a plurality of applications, wherein each of said applications has a logging engine with a log writer; producing a log file from each of said log writers; associating a metadata file with said log files; and retrieving a plurality of log information from said metadata file based on a search criteria and appropriate means and computer-readable instructions.

### TECHNICAL FIELD

The presently preferred embodiment of the innovations described herein relate generally to software applications. More specifically, the presently preferred embodiment relates to managing error logs from distinct software applications across a computer network.

### BACKGROUND

The Internet world of today is driven by Internet applications that make extensive use of web services, or simply, services. Services are defined by the World Wide Web Consortium (www.w3.org) as a software system designed to support interoperable machine to machine interaction over a network. They are also thought of as application programming interfaces (APIs) that can be accessed over a network like the Internet and executed on a remote system hosting the requested service. For every new service, new code and configurations are developed in a manner followed by commonly known software development processes.

In the various software development processes, there is a series of steps that take a software product from concept through to maintenance. One of the later steps, occurring before product release, is that of testing and debugging. Debugging is the methodical process of finding and reducing the number of bugs, or defects, in the software program to further the goal of deploying the software product. As anyone who had ever programmed software can attest, debugging problems can involve enormous amounts of time, and will sometimes lead to completely re-working thousands of lines of code. Consequently, tracking down debugging issues that cross multiple products or services requires querying several machines at potentially inconvenient locations, and datamining throughout vast directories and multiple log files.

For the end-user of a multi-tiered application there are potentially thousands of messages posted to log depositories related from the mundane operation to critical job-terminating faults. The end-user needs the ability to query the multi-tiered application for those logs in order to identify and correct, in near real time, operational failures.

What is needed is a system and method for managing error logs files from a multitude of programs and services use the same mechanism, appear transparent, and write to the same managed log volume location to effectively reduce time in identifying problems while improving productivity in using, finding and interpreting error log data information.

### SUMMARY

To achieve the foregoing, and in accordance with the purpose of the presently preferred embodiment as broadly described herein, the present application provides a method for managing a plurality of software logs across a multi-tiered network having multiple depositories, comprising establishing a plurality of applications, wherein each of said applications has a logging engine with a log writer; producing a plurality of log files from each of said log writers; associating a plurality of metadata files with said plurality of log files; and retrieving a plurality of log information from said plurality of metadata based on a search criteria. The method, further comprising: displaying said plurality of log information to an end user through a client-side graphical user interface. The method, wherein said plurality of applications are one of application processes and services. The method, wherein said retrieving of log information occurs across a logical centralized log repository that is distributed among a plurality of physical computers. The method, wherein said retrieval of log information occurs using nested queries. The method, wherein said retrieval of log information includes expanding a query capability to include a plurality of boolean operators. The method, wherein said plurality of boolean operators are one of OR and XOR.

Another advantage of the presently preferred embodiment is to provide a computer-program product tangibly embodied in a machine readable medium to perform a computer-program product tangibly embodied in a machine readable medium to perform a method for managing a plurality of software logs across a multi-tiered network having multiple log depositories, comprising instructions operable to cause a computer to establish a plurality of applications, wherein each of said applications has a logging engine with a log writer; produce a plurality of log files from each of said log writers; associate a plurality of metadata files with said plurality of log files; and retrieve a plurality of log information from said plurality of metadata based on a search criteria. The computer-program product, further comprising instructions to display said plurality of log information to an end user through a client-side graphical user interface. The computer-program product, wherein said plurality of applications are one of application processes and services. The computer-program product, wherein said retrieving of log information occurs across a logical centralized log repository that is distributed among a plurality of physical computers. The computer-program product, wherein said retrieval of log information occurs using nested queries. The computer-program product, wherein said retrieval of log information includes expanding a query capability to include a plurality of boolean operators. The computer-program product, wherein said plurality of boolean operators are one of OR and XOR.

And another advantage of the presently preferred embodiment is to provide a computer-program product tangibly embodied in a machine readable medium to perform a data processing system having at least a processor and accessible memory to implement a method for managing a plurality of software logs across a multi-tiered network, comprising means for establishing a plurality of applications, wherein each of said applications has a logging engine with a log writer; means for producing a plurality of log files from each of said log writers; means for associating a plurality of metadata files with said plurality of log files; and means for retrieving a plurality of log information from said plurality of metadata based on a search criteria.

Other advantages of the presently preferred embodiment will be set forth in part in the description and in the drawings that follow, and, in part will be learned by practice of the presently preferred embodiment. The presently preferred embodiment will now be described with reference made to the following Figures that form a part hereof. It is understood that other embodiments may be utilized and changes may be made without departing from the scope of the presently preferred embodiment.

### BRIEF DESCRIPTION OF THE DRAWINGS

A presently preferred embodiment will hereinafter be described in conjunction with the appended drawings, wherein like designations denote like elements, and:

FIG. 1 is a logic flow diagram of the method employed by the presently preferred embodiment;

FIG. 2 is a dataflow diagram of a system design in the presently preferred embodiment;

FIG. 3 is an illustration of a data flow diagram for the query and retrieval of log data;

FIG. 4 is an example illustration of a client GUI; and

FIG. 5 is a block diagram of a computer environment in which the presently preferred embodiment may be practiced.

### DETAILED DESCRIPTION OF THE PREFERRED EMBODIMENTS

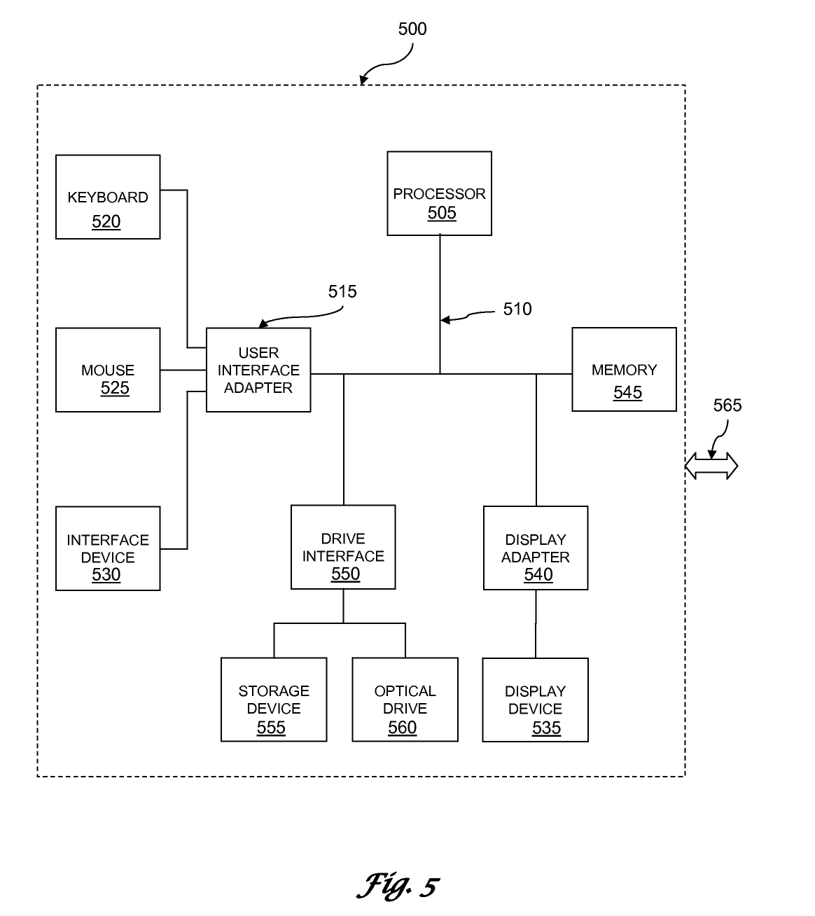

The numerous innovative teachings of the present application will be described with particular reference to the presently preferred embodiments. It should be understood, however, that this class of embodiments provides only a few examples of the many advantageous uses of the innovative teachings herein. The presently preferred embodiment provides, among other things, a system and method for managing error logs from distinct software applications across a computer network. Now therefore, in accordance with the presently preferred embodiment, an operating system executes on a computer, such as a general-purpose personal computer. FIG. 5 and the following discussion are intended to provide a brief, general description of a suitable computing environment in which the presently preferred embodiment may be implemented. Although not required, the presently preferred embodiment will be described in the general context of computer-executable instructions, such as program modules, being executed by a personal computer. Generally program modules include routines, programs, objects, components, data structures, etc., that perform particular tasks or implementation particular abstract data types. The presently preferred embodiment may be performed in any of a variety of known computing environments.

Referring to FIG. 5, an exemplary system for implementing the presently preferred embodiment includes a general-purpose computing device in the form of a computer 500, such as a desktop or laptop computer, including a plurality of related peripheral devices (not depicted). The computer 500 includes a microprocessor 505 and a bus 510 employed to connect and enable communication between the microprocessor 505 and a plurality of components of the computer 500 in accordance with known techniques. The bus 510 may be any of several types of bus structures including a memory bus or memory controller, a peripheral bus, and a local bus using any of a variety of bus architectures. The computer 500 typically includes a user interface adapter 515, which connects the microprocessor 505 via the bus 510 to one or more interface devices, such as a keyboard 520, mouse 525, and/or other interface devices 530, which can be any user interface device, such as a touch sensitive screen, digitized pen entry pad, etc. The bus 510 also connects a display device 535, such as an LCD screen or monitor, to the microprocessor 505 via a display adapter 540. The bus 510 also connects the microprocessor 505 to a memory 545, which can include ROM, RAM, etc.

The computer 500 further includes a drive interface 550 that couples at least one storage device 555 and/or at least one optical drive 560 to the bus. The storage device 555 can include a hard disk drive, not shown, for reading and writing to a disk, a magnetic disk drive, not shown, for reading from or writing to a removable magnetic disk drive. Likewise the optical drive 560 can include an optical disk drive, not shown, for reading from or writing to a removable optical disk such as a CD ROM or other optical media. The aforementioned drives and associated computer-readable media provide non-volatile storage of computer readable instructions, data structures, program modules, and other data for the computer 500.

The computer 500 can communicate via a communications channel 565 with other computers or networks of computers. The computer 500 may be associated with such other computers in a local area network (LAN) or a wide area network (WAN), or it can be a client in a client/server arrangement with another computer, etc. Furthermore, the presently preferred embodiment may also be practiced in distributed computing environments where tasks are performed by remote processing devices that are linked through a communications network. In a distributed computing environment, program modules may be located in both local and remote memory storage devices. All of these configurations, as well as the appropriate communications hardware and software, are known in the art.

Software programming code that embodies the presently preferred embodiment is typically stored in the memory 545 of the computer 500. In the client/server arrangement, such software programming code may be stored with memory associated with a server. The software programming code may also be embodied on any of a variety of non-volatile data storage device, such as a hard-drive, a diskette or a CD-ROM. The code may be distributed on such media, or may be distributed to users from the memory of one computer system over a network of some type to other computer systems for use by users of such other systems. The techniques and methods for embodying software program code on physical media and/or distributing software code via networks are well known and will not be further discussed herein.

### SYSTEM

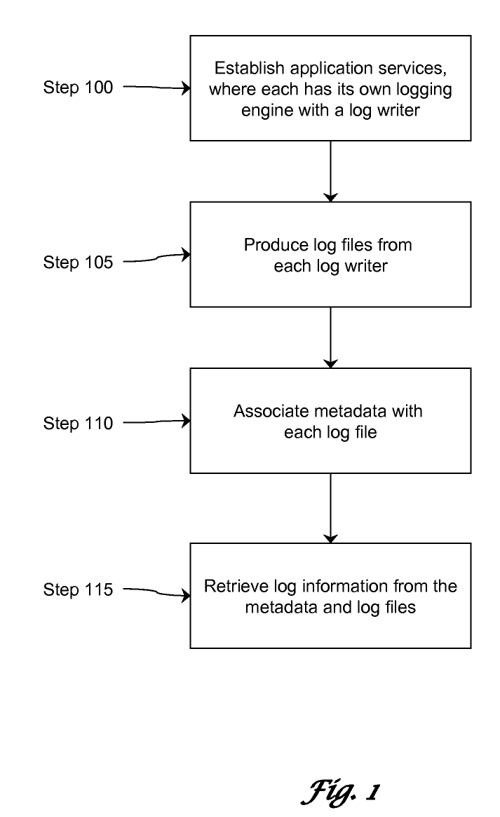

FIG. 1 is a logic flow diagram of the method employed by the presently preferred embodiment. Referring to FIG. 1, the presently preferred embodiment discloses a method for managing log files across a networked system where various web services and/or program applications has a logging engine with a log writer (Step 100). The log writers produce log files that contain program and/or service information related to the operation of the program and/or service (Step 105). Each of the log writers associate a metadata file with a log file, such that each program and/or service has not only an associated log file, but also an associated metadata file (Step 110). Query and retrieve log information from the log files and metadata files (Step 115).

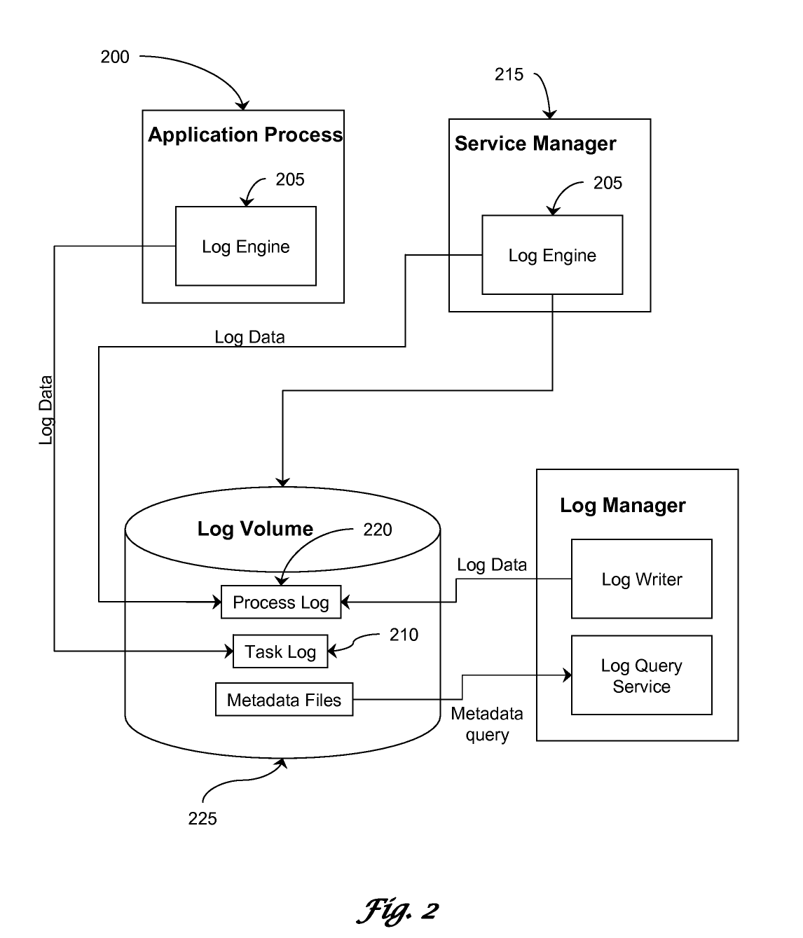

FIG. 2 is a dataflow diagram of a system design in the presently preferred embodiment where an application process 200, also referred to as a service or a web service, initializes a log engine 205. The process to initialize the log engine 205 reads a configuration file (not depicted) that defines the format written by the log engine 205. Once the underlying log engine 205, for example, Log4j or JDK Logger or Simple Logger, is initialized the application process 200 retrieves a task log object and a process log object from the log engine 205. The log engine 205 can have various types of log data produced that are, for example, DEBUG, INFO, WARN, ERROR, and FATAL. Based on retrieving the aforesaid objects, the log engine 205 writes the log data to a task log 210, if the log data is directly from the application process 200. However, if the log data is from a service manager 215, the log data is sent to a process log 220. Both the task log 210 and the process log 220 are located on a log volume 225 that can be a directory on a non-dedicated shared server, a stand-alone server dedicated to log data, or a distributed structure where the log data is distributed across multiple volumes and multiple systems for redundancy purposes. But the primary purpose of the presently preferred embodiment is to capture log data on the machine of execution/operation so that there are then multiple log depositories, i.e., the log depositories are distributed to avoid the performance overhead of a central repository. Once the recordation of log data is complete for the application process 200 or the service manager 215, the logging is done and the application or the process releases all of the logger handlers or other hooks by using a remove or removeall procedure method on the log engine 205.

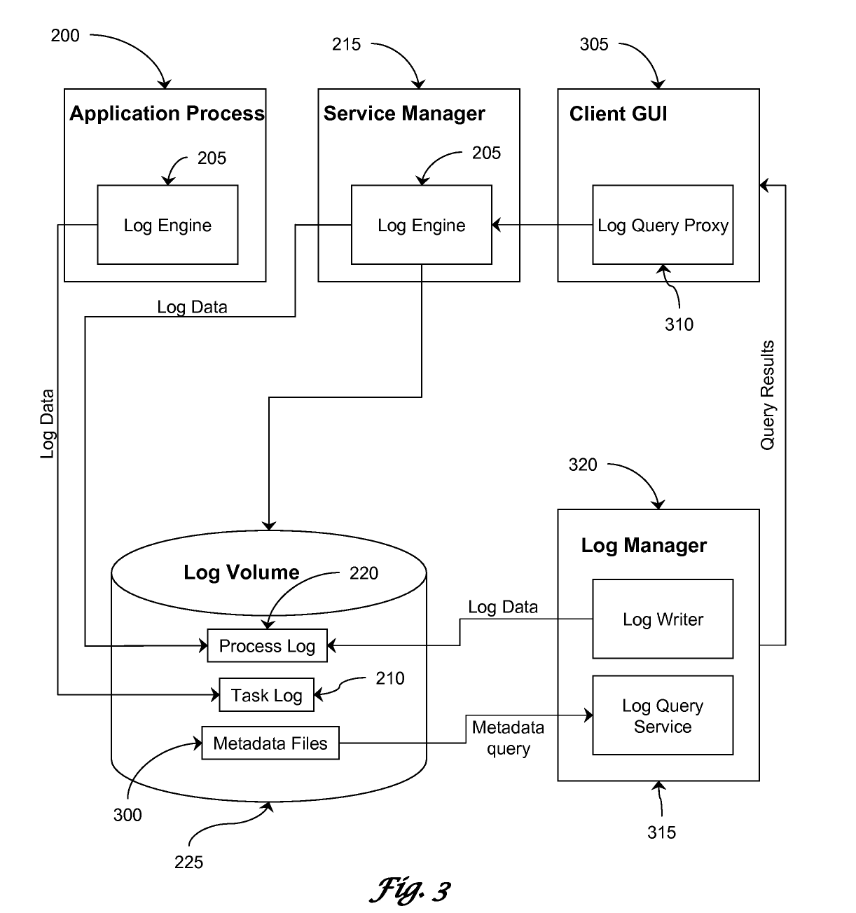

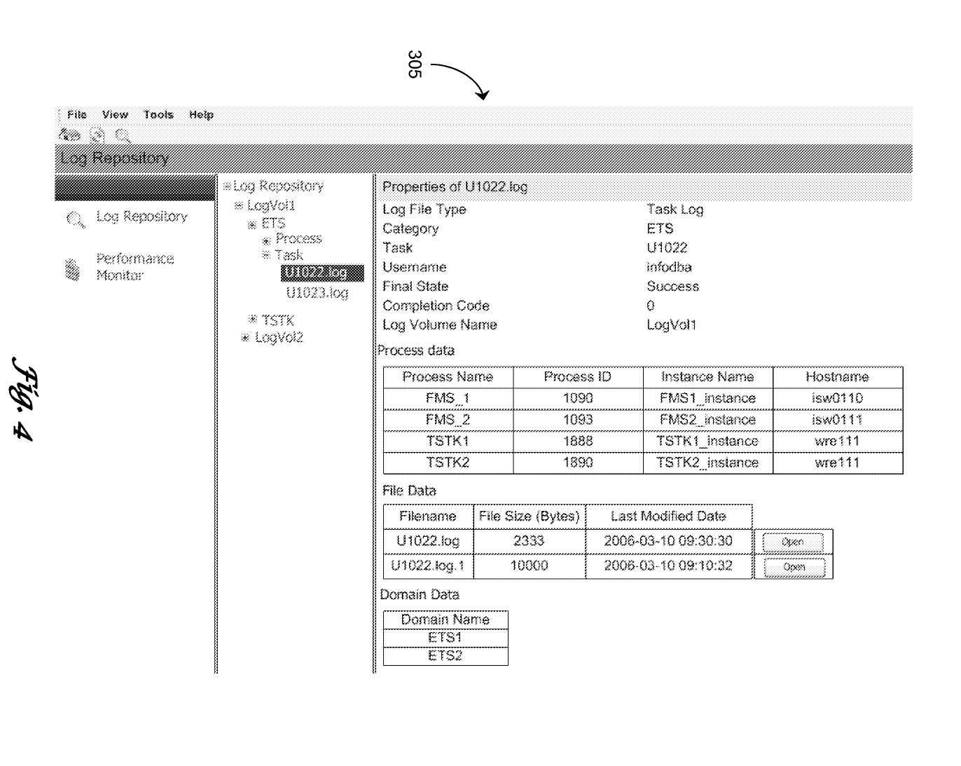

FIG. 3 is an illustration of a data flow diagram for the query and retrieval of log data. Referring to FIG. 3, the service manager 215 initializes and reads a configuration file from a configuration manager (both not depicted), where the configuration file contains information about the log volume 225 to get access to metadata files 300. When a user utilizes a client GUI 305 to query information in the log volume 225, a log query proxy 310 sends the request via the service manager 215. The client GUI 305 is illustrated as an example screen shot in FIG. 4. The log query functions read the metadata files 300 and sends the query results to a log query service 315 in a log manager 320. The query results are then returned to the user through the client GUI where they are printed, displayed, or otherwise saved for further use/retrieval. And it is through the GUI's query mechanism where it displays as though all log depositories are one logical central log repository, when in fact it is distributed.

### CONCLUSION

The presently preferred embodiment may be implemented in digital electronic circuitry, or in computer hardware, firmware, software, or in combinations thereof. An apparatus of the presently preferred embodiment may be implemented in a computer program product tangibly embodied in a machine-readable storage device for execution by a programmable processor; and method steps of the presently preferred embodiment may be performed by a programmable processor executing a program of instructions to perform functions of the presently preferred embodiment by operating on input data and generating output.

The presently preferred embodiment may advantageously be implemented in one or more computer programs that are executable on a programmable system including at least one programmable processor coupled to receive data and instructions from, and to transmit data and instructions to, a data storage system, at least one input device, and at least one output device. The application program may be implemented in a high-level procedural or object-oriented programming language, or in assembly or machine language if desired; and in any case, the language may be a compiled or interpreted language.

Generally, a processor will receive instructions and data from a read-only memory and/or a random access memory. Storage devices suitable for tangibly embodying computer program instructions and data include all forms of nonvolatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially-designed ASICs (application2—specific integrated circuits).

A number of embodiments have been described. It will be understood that various modifications may be made without departing from the spirit and scope of the presently preferred embodiment, such as using nested queries or expanding the query capability to boolean operators like OR and XOR, etc. Therefore, other implementations are within the scope of the following claims.

What is claimed is:

1. A method for managing a plurality of software logs across a multi-tiered network having multiple depositories, comprising:
establishing a plurality of applications, wherein each of said applications has a logging engine with a log writer;
producing a log file from each of said log writers;
associating a metadata file with said log files; and
retrieving a plurality of log information from said metadata files based on a search criteria.

2. The method of claim 1, further comprising displaying said log information to an end user through a client-side graphical user interface.

3. The method of claim 1, wherein said plurality of applications are one of application processes and services.

4. The method of claim 1, wherein said retrieving of log information occurs across a logical centralized log repository that is distributed among a plurality of physical computers.

5. The method of claim 1, wherein said retrieval of log information occurs using nested queries.

6. The method of claim 1, wherein said retrieval of log information includes expanding a query capability to include a plurality of boolean operators.

7. The method of claim 6, wherein said plurality of boolean operators are one of OR and XOR.

8. A computer-program product tangibly embodied in a machine readable medium to perform a method for managing a plurality of software logs across a multi-tiered network having multiple log depositories, comprising instructions operable to cause a computer to:
establish a plurality of applications, wherein each of said applications has a logging engine with a log writer;
produce a log file from each of said log writers;
associate a metadata file with said log files; and
retrieve a plurality of log information from said metadata file based on a search criteria.

9. The computer-program product of claim 8, further comprising instructions to display said plurality of log information to an end user through a client-side graphical user interface.

10. The computer-program product of claim 8, wherein said plurality of applications are one of application processes and services.

11. The computer-program product of claim 8, wherein said retrieving of log information occurs across a logical centralized log repository that is distributed among a plurality of physical computers.

12. The computer-program product of claim 8, wherein said retrieval of log information occurs using nested queries.

13. The computer-program product of claim 8, wherein said retrieval of log information includes expanding a query capability to include a plurality of boolean operators.

14. The computer-program product of claim 13, wherein said plurality of boolean operators are one of OR and XOR.

15. A data processing system having at least a processor and accessible memory to implement a method for managing a plurality of software logs across a multi-tiered network, comprising:
means for establishing a plurality of applications, wherein each of said applications has a logging engine with a log writer;
means for producing a log file from each of said log writers;
means for associating a metadata file with said log file; and
means for retrieving a plurality of log information from said metadata file based on a search criteria.
